(19) United States
(12) Patent Application Publication
(10) Pub. No.: US 2002/0105671 A1
(43) Pub. Date: Aug. 8, 2002

(54) PRINTING SYSTEM

(76) Inventor: YOSHINORI SUGAHARA, KYOTO-SHI (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/178,887

(22) Filed: Oct. 27, 1998

(30) Foreign Application Priority Data
Oct. 31, 1997 (JP) 09-300181

(51) Int. Cl. G06K 15/02; G06F 3/12; G06F 13/00

(52) U.S. Cl. 358/1.15

(57) ABSTRACT

A print system and method of using includes a print server; at least one printer connected to the print server; a plurality of computers connected to the print server; the print server includes a job observation stationary module for monitoring the status of the printer connected to the print server; and each of the computers includes a status monitor for displaying the status of the printer connected to the print server. The method includes monitoring a status of a printer with a print server; sending the status of the printer to a plurality of computers connected to the print server; and displaying the status of the printer connected to the print server.

This application is based on application No. 9-300181 filed in Japan on Oct. 31, 1997, the content of which is hereby incorporated by reference.

### BACKGROUND OF THE INVENTION

1. Field of the Invention

The present invention relates to a network type print system in which a plurality of data processing devices are connected with printers via a print server.

2. Description of Related Art

In a general office automation (OA) network, a plurality of computers share printers. Multiple apparatus capable of copying or facsimile communication may be used as a printer. A print server for collectively administrating print jobs is provided, especially in a large scale network. As to printer selection in a network to which two or more printers are connected, the following types may be used: the type that each computer is fixedly allotted a printer, the type that a user designates a printer to be used at every print job, and the type that the print server automatically adapts each printer by a print job unit in accordance with the use condition of the printers.

Japanese laid-open patent application No. HEI6-247013 discloses a print server providing the expected print start time in response to an inquiry by a computer.

Conventionally, in spite of the concentration of print jobs to a specific printer, a computer operator may send a print job to that printer, which requires the operator to wait for print start for a long time. The operator who sees the print condition displayed on a computer in response to a print request, may then require the print job be sent again to another printer instead of the previously requested printer. As a result, printing is duplicated in some cases which wastes paper and toner.

### OBJECTS AND SUMMARY

Considering the aforesaid circumstances, the present invention aims to provide an improved print system.

Another object of the present invention is to provide a print system capable of executing efficient print operation.

Still another object of the present invention is to provide a print system convenient for use, by which a user is able to select a printer or postpone printing confirming the use condition of printers.

To accomplish the aforesaid and other objects, the print system of the present invention includes a plurality of printers, a plurality of clients which are data processing devices using these printers, and a print server which collectively administrates the use of said printers. The aforesaid print server notifies the use condition of said printers simultaneously to all clients in a log-in state. Each of said clients displays the use condition notified by said print server. Accordingly, each client always displays, for example, the use condition of all printers permitted to use, irrespective of the presence of print request. The use condition includes operation condition, trouble condition and waiting time for new printing. A user of the print system who operates a client is able to take an appropriate process, such as designating the printer of the shortest waiting time to request printing or postponing printing, thereby excessive concentration of print requests is prevented.

### BRIEF DESCRIPTION OF THE DRAWINGS

These and other objects and features of the present invention will become apparent from the following description of a preferred embodiment thereof taken in conjunction with the accompanying drawings, in which:

FIG. 1 is a view of a print system,

FIG. 2 is an illustration showing an example of a printer condition screen,

FIGS. 3(A), 3(B) and 3(C) show the summary of a waiting time display procedure

FIGS. 4(A), 4(B) and 4(C) show a client registration procedure,

FIGS. 5(A), 5(B) and 5(C) show a server registration procedure,

FIG. 6 is a flowchart showing an operation control procedure of a client, and

FIG. 7 is a flowchart showing an operation control procedure of a server.

In the following description, like parts are designated by like reference numbers throughout the several drawings.

### DETAILED DESCRIPTION OF THE PREFERRED EMBODIMENTS

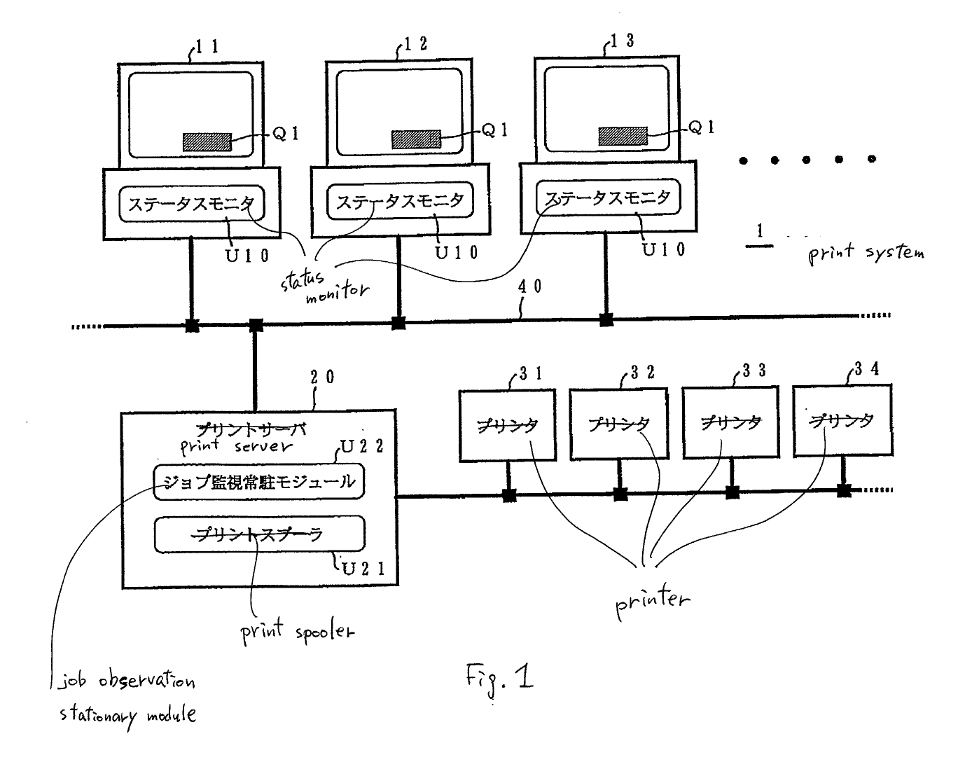

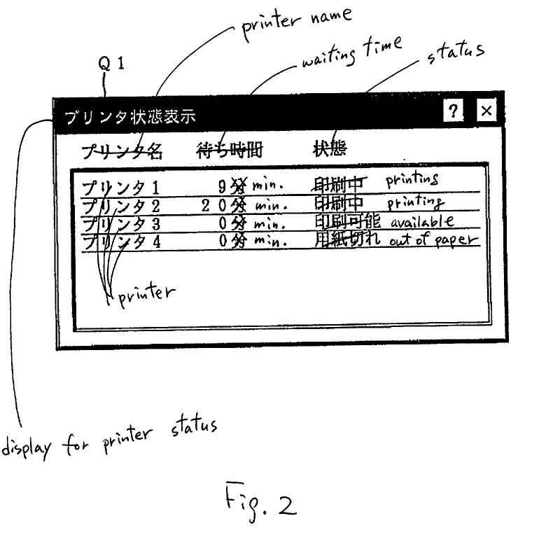

FIG. 1 is an illustration of a print system 1. FIG. 2 is an illustration showing an example of a printer condition screen Q1.

The print system 1 is a part of an OFFICIAL ACTION network which intercommunicatably connects a plurality of data processing devices including computers 11, 12 and 13, and provides four printers 31, 32, 33 and 34 and a print server 20 for collectively administrating the printers 31 to 34. All the printers 31 to 34 are connected with a network cable 40 via the print server 20. The printers 31 to 34 may incorporate a network interface card (NIC) therein to be directly connected with the network cable 40. The print server 20 may be either a device for exclusive use thereof or a multi-function device having both the server function and the client function. The printer server 20 may be incorporated in the printer 31.

A print spooler U21 for administrating the schedule of the printers 31 to 34 as well as a job observation stationary module U22 for grasping the use condition of the printers 31 to 34 are incorporated in the print server 20. A status monitor U10 for displaying the printer condition screen Q1 is incorporated in all the computers 11 to 13 as clients using the printers 31 to 34. The job observation stationary module U22 and the status monitor U10 are characteristic utilities of the present invention, and link with each other to display the use condition of the printers 31 to 34 on real time.

The printer condition screen Q1 in FIG. 2 displays the operational condition (status) and the time required to complete a print job during printing or waiting for printing (waiting time) concerning all the printers 31 to 34 as a list. Operators of the computers 11 to 13 are able to optionally change the display position of the printer condition screen Q1 on the display, and to close the window of the printer condition screen Q1 if unnecessary or desired.

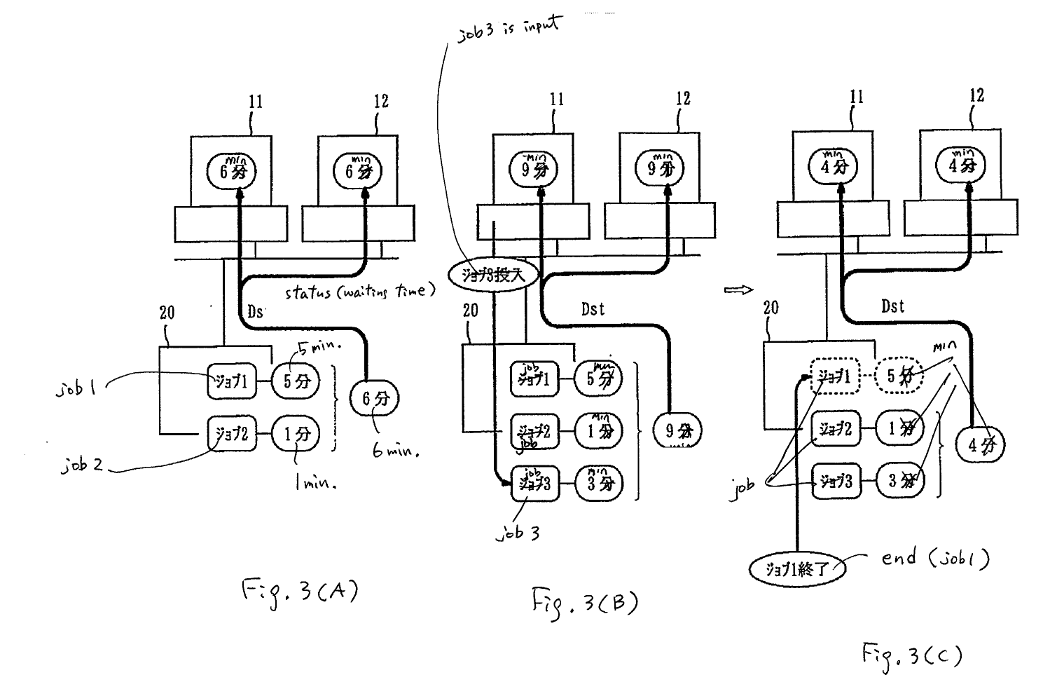

FIGS. 3(A), 3(B) and 3(C) show the summary of the waiting time display. The case described hereinafter has two computers 11 and 12 as clients and only one printer is used.

Two print jobs are inputted to the print server 20 in the step of FIG. 3(A). For example, if the first print job during printing is expected to be completed after five minutes and the second print job waiting for printing is expected to require one minute, the waiting time is “six minutes”. Use condition data Dst including this waiting time is sent to the computers (clients) 11 and 12 from the print server 20 simultaneously, and the status monitor U10 of each computer 11 and 12 displays “six minutes” as the waiting time. If the third print job is inputted by one computer 11 in the aforesaid state as shown in FIG. 3(B), the job observation stationary module U22 of the print server 20 calculates the required time. If the calculated value is “3 minutes”, the waiting time is “nine minutes”. The latest waiting time is simultaneously notified to the computers (clients) 11 and 12, and the waiting time display of the printer condition screen Q1 is updated from “six minutes” to “nine minutes”. When the printing of the first print job is completed thereafter, the new waiting time (“four minutes”), obtained by deducing the time required for the first print job, is simultaneously used to update the contents of the printer condition screen Q1 as shown in FIG. 3(C).

The waiting time does not need to be calculated by print job units. For example, the advancing condition of printing may be minutely observed by a predetermined page numbers unit to update the waiting time display one after another during the printing of one print job. With such a control, even in the condition that the great part of the print jobs are the ones of a large number of pages, the gap between the displayed waiting time and the actual waiting time is able to be minimized. However, it is to be noted that minute display update may cause overcrowding of the network.

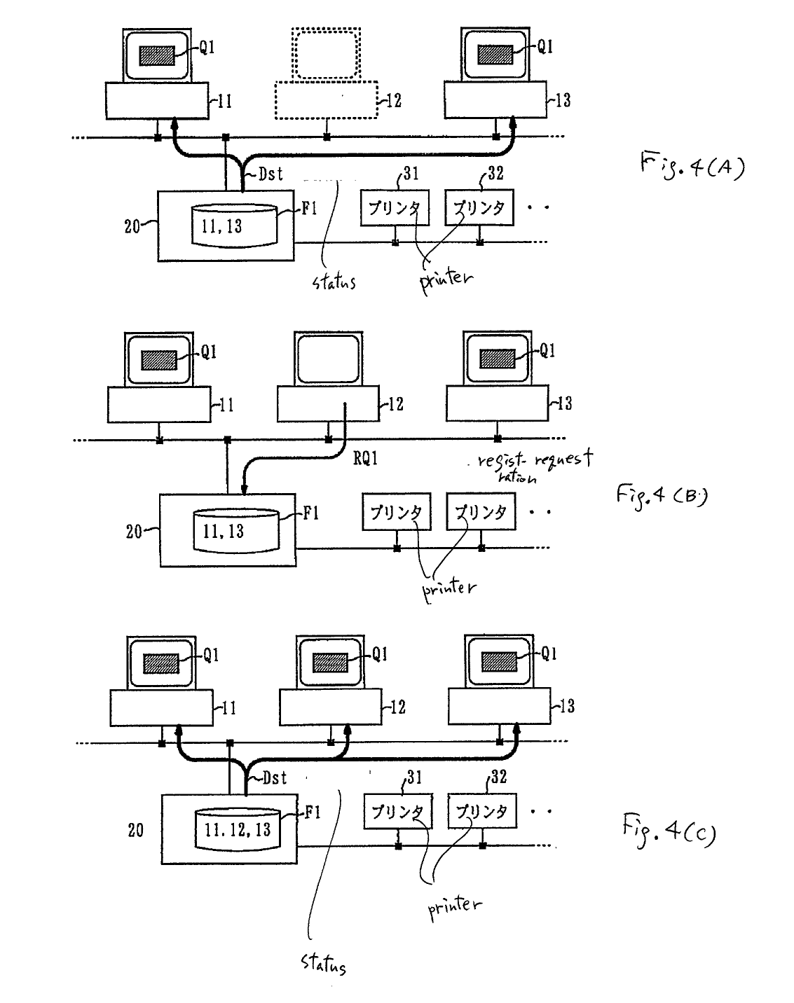

FIGS. 4(A), 4(B) and 4(C) show client registration.

In the print system 1, the print server 20 sends the use condition data Dst to the clients that are physically and logically connected therewith. Thus, when a computer is newly connected with the network, or when power is turned on, the corresponding computer must register with the print server 20.

The computers 11 and 13 are operating and the computer 12 is not operating in the step of FIG. 4(A). A client administration file F1 is provided in the print server 20, and the computers 11 and 13 during operation are registered thereto as clients. When the power of the computer 12 is turned on, the computer 12, which newly starts operation, outputs a registration request signal RQ1 to the print server 20 as shown in FIG. 4(B). In response thereto, the print server 20 accepts the computer 12 as a client and updates the client administration file F1. Thereafter, the use condition data Dst is sent to the three computers 11, 12 and 13 to display the printer condition screen Q1 of the same contents on all computers 11 to 13.

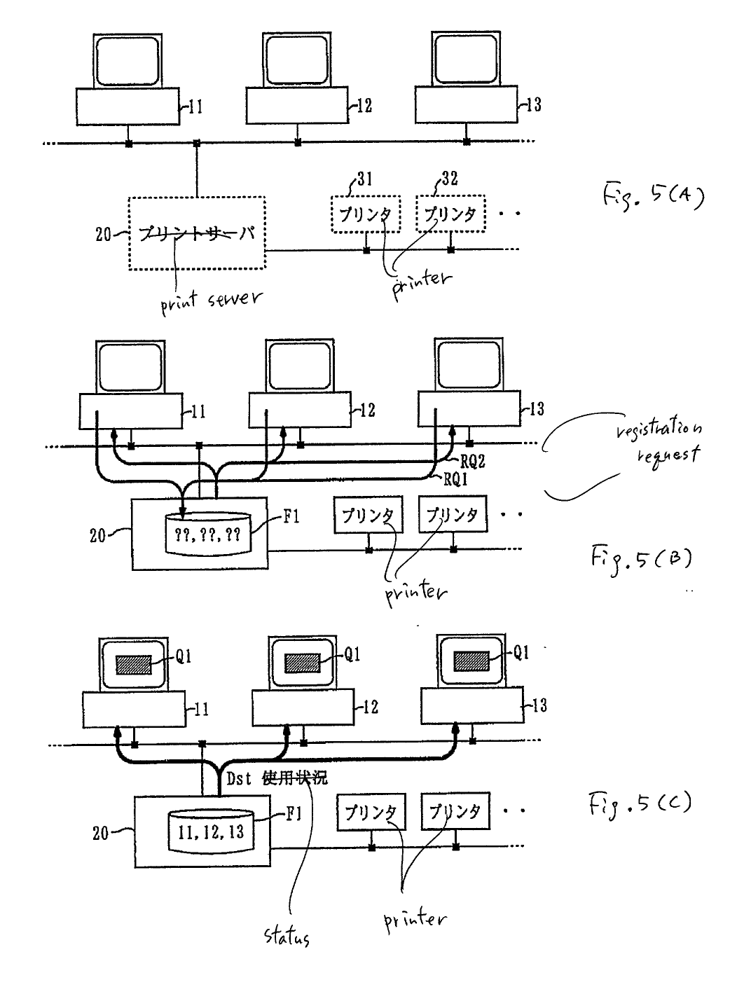

FIGS. 5(A), 5(B) and 5(C) show server registration.

Even in an OA network operating all day, the use of the printers 31 to 34 is mostly limited to a certain time slot during the day according to the convenience of a paper supplier and the like. Namely, the power of the printers 31 to 34 are off during the night in general. Accordingly, in some cases, not only the printers 31 to 34 but also the print server 20 do not operate. FIG. 5(A) shows the condition that the computers 11 to 13 are operating, but the printers 31 to 34 and the print server 20 are not operating.

When the power of the print server 20 is turned on, the print server 20 outputs server registration request signals RQ2 to the network as shown in FIG. 5(B). In response thereto, each computer 11 to 13 outputs a registration request signal RQ1 to the print server 20 at an appropriate timing. The print server 20 accepts the computers 11 to 13 which output the registration request signal RQ1, as described above, as clients, and writes client discrimination information to the client administration file F1. Then, the use condition data Dst is sent to the three computers 11, 12 and 13 to display the printer condition screen Q1 of the same contents on all computers 11 to 13. On this occasion, if the power of the printers are not turned on, the display showing that the printers are unavailable is displayed.

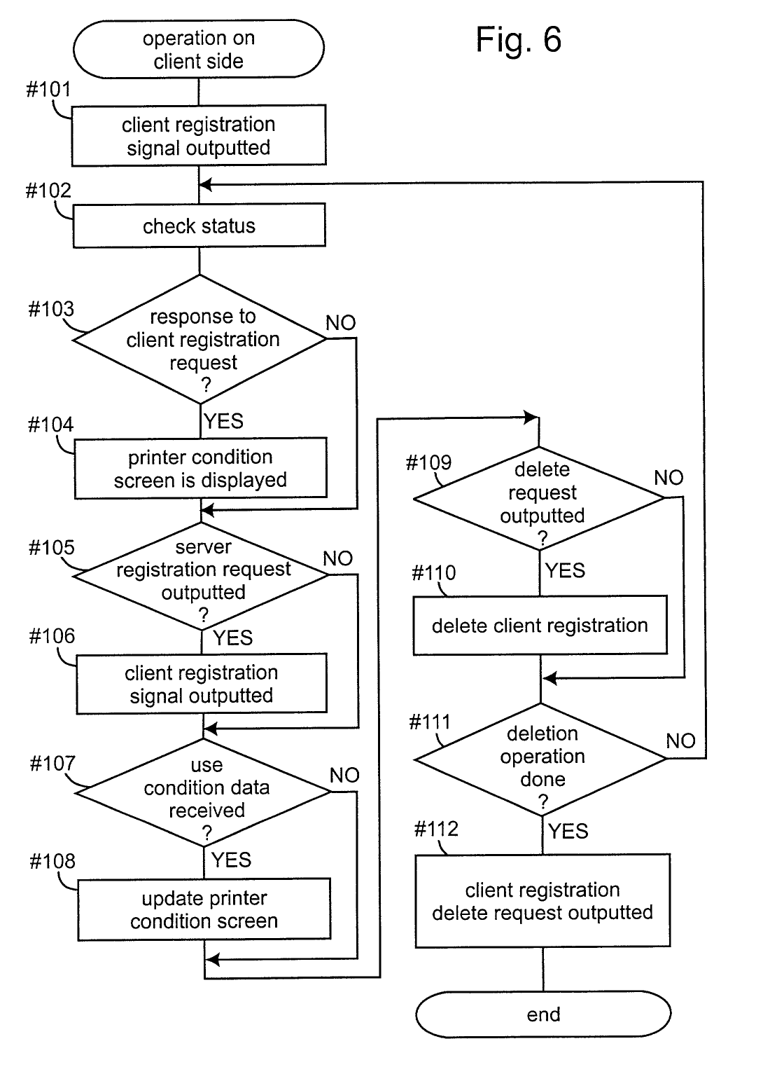

FIG. 6 is a flowchart of the operation of the client computer.

When the status monitor U10 is started by the operating system (OS), the status monitor U10 requests the client to register with the job observation stationary module U22 of the print server 20 at first in step #101. Then, the status of the network is observed in step #102, and the following procedure corresponding to the status is executed.

If an acceptance response to the client registration request is outputted, the registration condition of the print server 20 is updated and the printer condition screen Q1 is displayed as a monitor screen in steps #103 and #104. In the case that the server starts to operate later than the clients and the server registration request is outputted as described above, the client registration request signal is outputted in response to that request in steps #105 and #106. When the use condition data Dst is received by the clients, the contents of the printer condition screen Q1 are updated in steps #107 and #108. If a request is sent from a client to remove the client from the system, the registration in the print server 20 is deleted in steps #109 and #110. When a completion operation for designating shutdown of the power source is performed, client registration delete request is outputted to complete the process in steps #111 and #112.

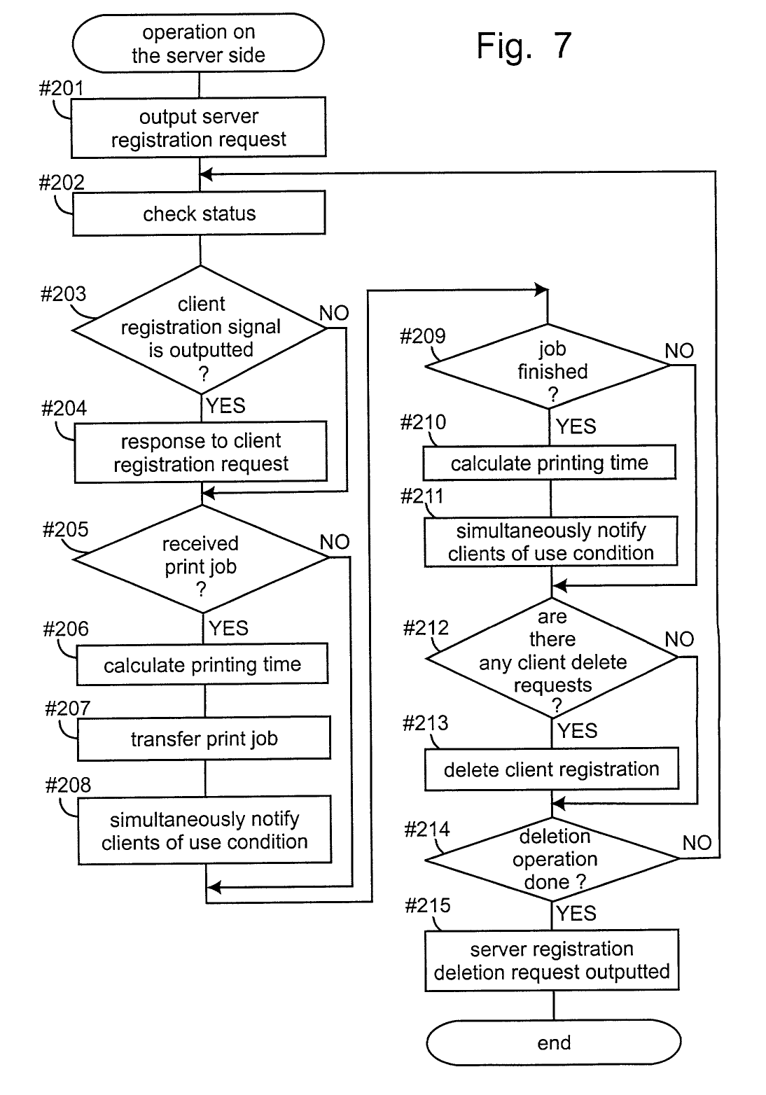

FIG. 7 is a flowchart of the operation of the server.

When the job observation stationary module U22 is started by OS, it outputs the server registration request RQ2 at first in step #201. Then, the status of the network is observed in step #202, and the following process corresponding to the event is executed.

If client registration request RQ2 is outputted, the client administration file F1 is updated to notify the effect of the acceptance to the status monitor U10 in steps #203 and #204. When a print job is received, the time required for printing is calculated and the print job is transferred to the print spooler U21 to simultaneously notify the use condition in steps #205 to #208. In calculating the time required for printing, a data base is used which is prepared in advance and which specifies processing time for every page description. As to image data such as text data or bit map data, the required times for every data size unit are added up. When the notification of the completion of one print job is received from the print spooler U21 in step #209, the completed print job is excluded from the required time calculation to calculate the required time again in step #210, and the calculation result is simultaneously notified to the clients which are physically and logically connected and in the log-in state in step #211. If the client registration delete request is outputted, the registration of the corresponding client is deleted in steps #212 and #213. If the completion operation for designating the shutdown of the power source is executed, the server registration delete request is outputted to complete the process in steps #214 and #215.

In the aforesaid embodiment, a plurality of print servers 20 may be provided to divide the administration of the printers 31 to 34. In this case, only the servers 20 which output the server registration request accept the client registration request of the computers 11 to 13 which responds to the server registration request, and the other printer servers 20 ignore the client registration request. The number of clients and the number of printers are not limited to those of the embodiment.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A print system, comprising:
a print server;
at least one printer connected to the print server;
a plurality of computers connected to the print server;
the print server includes a job observation stationary module for monitoring the status of the printer connected to the print server; and
each of the computers includes a status monitor for displaying the status of the printer connected to the print server.

2. The print system of claim 1, further comprising a plurality of printers connected to the print server.

3. The print system of claim 2, further comprising means for a user of one of the plurality of computers to designate a particular one of the plurality of printers for a particular print job.

4. The print system of claim 1, further comprising means for a user of one of the plurality of computers to postpone a particular print job.

5. The print system of claim 2, further comprising means for a user of one of the plurality of computers to postpone a particular print job.

6. The print system of claim 1, wherein the status monitor of each of the plurality of computers includes means for displaying an operating condition, a trouble condition, and a waiting time for the printer.

7. The print system of claim 1, wherein the print server includes means for sending a registration request to each of the plurality of computers.

8. The print system of claim 7, wherein each of the plurality of computers includes means for sending a registration signal to the print server in response to the registration request.

9. The print system of claim 1, wherein each of the plurality of computers includes means for sending a registration signal to the print server.

10. The print system of claim 1, wherein the print server includes means for calculating a waiting time for availability of the printer.

11. A method of controlling a print system, comprising the steps of:
monitoring a status of at least one printer with a print server;
sending the status of the printer to a plurality of computers connected to the print server; and
displaying the status of the printer connected to the print server.

12. The method of claim 11, wherein the monitoring step includes monitoring a status of a plurality of printers with the print server.

13. The method of claim 12, further comprising the step of designating a particular one of the plurality of printers for a particular print job.

14. The method of claim 11, further comprising the step of postponing a particular print job.

15. The method of claim 11, further comprising the step of displaying on at least one of the plurality of computers an operating condition, a trouble condition, and a waiting time for the printer.

16. The method of claim 12, further comprising the step of displaying on at least one of the plurality of computers an operating condition, a trouble condition, and a waiting time for each of the plurality of printers.

17. The method of claim 11, further comprising the step of sending a registration request from the print server to each of the plurality of computers.

18. The method of claim 17, further comprising the step of sending a registration signal from at least one of the plurality of computers to the print server in response to the registration request.

19. The method of claim 11, further comprising the step of sending a registration signal from at least one of the plurality of computers to the print server.

20. The method of claim 11, further comprising the step of calculating a waiting time for availability of the printer.

21. The method of claim 12, further comprising the step of calculating a waiting time for availability of each of the plurality of printers.
